(19) United States
(12) Patent Application Publication
(10) Pub. No.: US 2003/0081849 A1
(43) Pub. Date: May 1, 2003

(54) Method and system for creating seamless textured three dimensional models of objects

(76) Inventor: Joshua Edward Smith, Barre, MA (US)

Correspondence Address: MINTZ, LEVIN, COHN, FERRIS,, GLOVSKY and POPEO, P.C., One Financial Center, Boston, MA, 02111, US

(21) Appl. No.: 10/187,517

(22) Filed: Jul. 1, 2002

Related U.S. Application Data
(60) Provisional application No. 60/315,505, filed on Aug. 28, 2001.
(60) Provisional application No. 60/305,572, filed on Jul. 16, 2001.

(51) Int. Cl. G06K 9/36

(52) U.S. Cl. 382/241

(57) ABSTRACT

A method and system for creating seamless textured three dimensional models of objects includes unwrapping a plurality of images, joining the plurality of images and feathering the textures of the images where transitions or seams are visible. The unwrapping process includes processing the images whereby the ratio of texture area to surface area is nearly constant across the model. This can be accomplished by selecting a starting polygon in a mesh of polygons and re-orienting each polygon adjacent to the starting polygon by rotating or projecting the polygon onto the plane of the starting polygon. Each polygon adjacent to a re-oriented polygon is also re-oriented until all the polygons are oriented into the plane of the starting polygon. Where re-orienting a polygon resulting in a gap or crack, one or more vertexes of the polygon can be relocated to avoid the gap, even though some distortion may occur. The process can be repeated several times as needed to provide a nearly constant ratio of texture area to surface area. Where the images are joined, a visible transition can appear which can be reduced by feathering. The feathering process can include performing a weighed copy of the texture on one side of the transition onto the other side of the transition in order to blend the adjacent textures. The weighted copy process provides for a linear decrease in the copy operation as the distance from the transition increases.

### CROSS-REFERENCE TO RELATED APPLICATIONS

This application claims the benefit of priority to U.S. S. No. 60/315,505 filed Aug. 28, 2001, and U.S. S. No. 60/305,572 filed Jul. 2, 2001, which are incorporated herein by reference in their entirety.

### STATEMENT REGARDING FEDERALLY SPONSORED RESEARCH

Not Applicable

### REFERENCE TO MICROFICHE APPENDIX

Not Applicable

### BACKGROUND OF THE INVENTION

The present invention is related to the production of textured 3D models of objects, where the texture information can be derived from actual photographs of the object being modeled. In addition to using actual photographs, the present invention can create a 3D model from digital images such as computer generated renderings of the object being modeled.

When one endeavors to represent a three dimensional object on a two dimensional displaying device, an important consideration in modeling the three dimensional object is to make it appear realistic. The representation of the object should have realistic geometric proportions as well as having texture that makes it look like the actual object would appear in three dimensional space. When representing a three dimensional object, geometric information can be obtained from sources such as CAD modeling, photogrammetric analysis of actual photographs of the object, laser depth scanning of the actual object, and analysis of light patterns projected on the 3D object. Each of these techniques, when used with three dimensional rendering, provides an accurate representation of the object's geometry. But each lacks information about the object's color and lighting cues that make the object look realistic.

In order to make a 3D model look more realistic, actual photographs of the object can be used to obtain texture information. This technique is not without its problems. Two such problems are inconsistent resolution and obvious transitions or “seams” within the 3D model. Obtaining resolution information from photographs can be problematic because the resolution of different sides of the object can vary depending upon the angle at which the photograph was taken. Similarly, transitions from one photograph to another, irrespective of whether there is overlap between the photographs, typically results in visible seams in the rendered 3D object. There is therefore a need for a system and method that produces 3D objects for subsequent rendering where the texture is realistically modeled and visible seams are reduced.

Accordingly, it is an object of this invention to provide an improved method and system for creating seamless textured three dimensional models of real objects.

### SUMMARY OF THE INVENTION

The system and method of the present invention is directed toward improved techniques for creating seamless representations of objects through the manipulation of texture maps that can be applied to models of 3D objects. In accordance with the present invention, a representation or image is processed whereby the ratio of texture area to surface area remains nearly constant across the object and the transition from one texture to an adjacent texture is nearly concealed. The processing can be controlled to selectively determine the degree to which the ratio of texture area to surface area remains constant and the degree to which the transition from one texture to another is concealed in order to meet the requirements of the particular application. Thus, in one embodiment, the ratio of texture area to surface area could be altered such that it is not nearly constant or the transition is not nearly as concealed as they could be, although the results obtained from these embodiments may be acceptable for one application, they may be less than optimum for another.

For purposes of explanation, the first of these techniques for modifying an image in order to provide a nearly constant ration between the texture area and the surface area, will be referred to herein as “unwrapping,” and the second technique for modifying an image in order to provide a nearly concealed transition between texture maps will be referred to as “feathering.”

In one embodiment of the invention, a three dimensional geometric model of a real object can be generated from any of the various well known modeling and image analysis techniques. The three dimensional model of the object can include a mesh of polygons, wherein each vertex of each polygon in the polygon mesh be associated with texture and geometrical information relating to the spatial correlation between the three dimensional model and the image used to provide the texture for that polygon in order to create the model. In accordance with the invention, the polygonal mesh can be unwrapped by arbitrarily choosing a starting polygon, and re-orienting (such as by rotating or projecting) each polygon adjacent to the starting polygon into the plane of the starting polygon and then re-orienting each polygon adjacent to a re-oriented polygon into the plane of the starting polygon. After each polygon has been re-oriented, it is stored as part of a set of re-oriented polygons.

In addition, after a particular polygon has been re-oriented, it one of its vertices is relatively close to a vertex corresponding to an already-re-oriented polygon, these two polygons are brought together by moving the adjacent vertexes to a common location. The common location can be the location of one of the vertexes or a location between the two. The resulting unwrapped polygons will have the benefit of being relatively free of cracks or open spaces.

If re-orienting a new polygon into the plane of the polygon chosen to be the starting polygon results in the new polygon overlapping another polygon that has already been re-oriented, the new polygon is not re-oriented and put back into the queue of polygons to be processed later. When there are no more polygons left in the queue to be processed, the set of processed polygons that has been generated is stored where it can subsequently be accessed.

After a first iteration, a set of polygons oriented into the plane of the starting polygon has been created, the steps described above can be performed again. In a second (or subsequent) iteration, a second (or subsequent) starting polygon is chosen and a second (or subsequent) set of re-oriented polygons is created using the steps described above. This embodiment can be utilized until each polygon in the mesh of polygons derived from the three dimensional model has been re-oriented and has become a part of a set of processed polygons. This can result in at least as many sets, and usually more sets than there were original textures.

Each set of polygons can then be rendered as an image using an affine transformation of the original textures, and suitable filtering, such as bilinear interpolation and box filtering. The set of images can then be stored separately, or merged into a set of composite images. The set of polygons or composite images can then be combined with other sets of polygons or composite images using the other technique referred to as feathering in order to create a 3D model of an object.

After a 3D model has been unwrapped, the seams are often visible where more than one photograph has been used to provide texture data for the model. The feathering process includes ensuring a smooth transition away from the seam. The feathering process includes the steps of identifying an edge or boundary line along which the texture is to be transitioned, overlaying a mirror image of the adjacent photograph onto the area to be feathered and using a weighted copy operation to copy the mirror image onto the area to be feathered. The weighted copy operation is used to vary the attributes (pixel color, saturation and brightness, for example) of the copied mirror image as a function of the distance from the edge or boundary line.

The resulting image is a 3D model of an object in which the transitions between the seams are less visible. In certain situations, either the unwrapping process or the feathering process can be used by itself to provide less visible transitions or seams, however the use of both processes has been found to provide better results than either process individually.

### BRIEF DESCRIPTION OF THE DRAWINGS

The foregoing and other objects of this invention, the various features thereof, as well as the invention itself, may be more fully understood from the following description, when read together with the accompanying drawings in which:

FIGS. 1A and 1B show a diagrammatic view of a model of an object that has been unwrapped in accordance with the invention;

FIG. 2 shows a flow chart of the unwrapping method of the invention;

FIG. 3 shows an unwrapped image of a heel of a shoe in accordance with the invention;

FIG. 4 shows a flow chart of the feathering method of the invention;

FIGS. 5A-5C show a diagrammatic view of the feathering process in accordance with the invention; and

FIGS. 6A and 6B show the image of FIG. 3 before and after feathering.

### DETAILED DESCRIPTION OF THE PREFERRED EMBODIMENTS

The system and method of the present invention is directed toward improved techniques for creating seamless three dimensional (“3D”) representations of objects through the manipulation of texture maps that can be applied to models of 3D objects. In order to facilitate a further understanding of the invention, the invention is further described below in various illustrative embodiments.

In the embodiments of the invention, a three dimensional geometric model can be generated from CAD modeling, photogrammetric analysis of photographs, laser depth scanning of the actual object, analysis of light patterns projected on the 3D object, and the like. These methods provide for the creation of a three dimensional model of an object that can be represented as a mesh of polygons, wherein texture coordinates at each vertex of the polygons in the polygon mesh include information about the spatial correlation between the three dimensional model and the images used to make the model more realistic. The images can be digitally encoded photographs of the object or a computer generated rendering of an image of the object.

The first of these techniques, referred to herein as unwrapping, can be applied to a polygon mesh which is a 3D model of a real object. The unwrapping process in accordance with the invention includes arbitrarily choosing a starting polygon, and rotating each polygon adjacent to the starting polygon into the plane of the starting polygon and then rotating each polygon adjacent to a rotated polygon into the plane of the starting polygon. After each polygon has been rotated, it is stored as part of a set of rotated polygons.

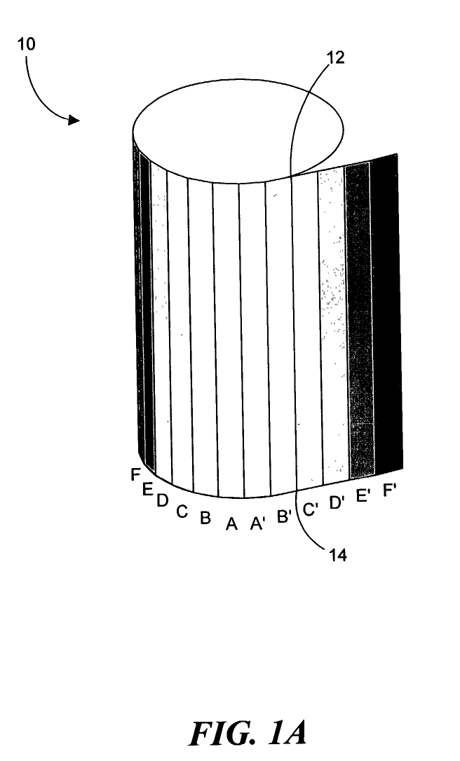

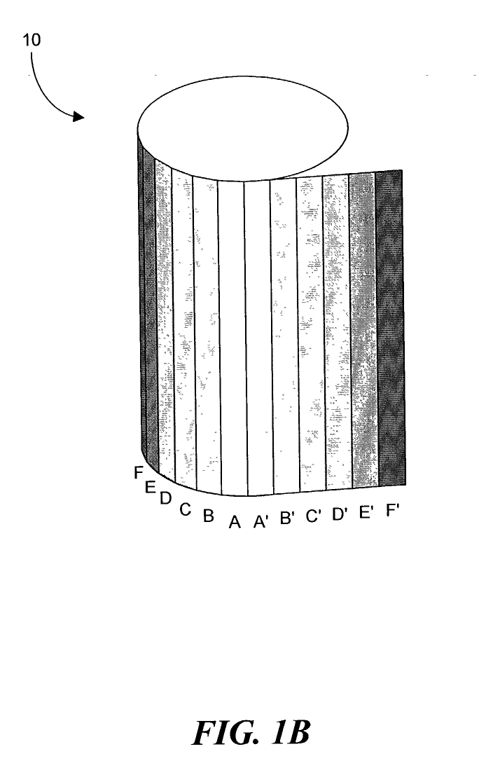

For purposes of illustration, a simplified mesh of a cylindrical object is shown in FIGS. 1A and 1B in order to illustrate the unwrapping process in accordance with the invention. FIG. 1A shows a representation of a cylindrical object 100 in which polygons A, B, C, D, E and F are shown in their original state and (mirror image) polygons C′, D′, E′ and F′ are shown in the unwrapped state when using polygon B′ as the starting polygon. Similarly, FIG. 1B shows the same representation after a second iteration wherein polygons B′, C′, D′, E′ and F′ are shown in the unwrapped state when using polygon A′ as the starting polygon.

In accordance with the invention, the polygonal mesh can be unwrapped by arbitrarily choosing a polygon, such as polygon B′ in FIG. 1A, as a starting polygon. After the starting polygon has been chosen, each adjacent polygon C′, as determined by the polygon's topological information, is rotated in succession into the plane of the starting polygon B′. Where the polygons share a common side, such as the side between vertex 12 and vertex 14, the adjacent polygon C′ can be rotated about that common side. As polygons are rotated, polygons that are adjacent to the polygon being rotated (polygons D′, E′ and F′) are queued to be rotated next. After each polygon has been rotated, the data representing that rotated polygon is stored as part of a set of rotated polygons.

In the illustrative embodiment, after a particular polygon has been rotated, if one of its vertices is relatively close to a vertex corresponding to an already-rotated polygon, these two polygons can be brought together by moving the adjacent vertexes to a common location. The common location can be the location of one of the vertexes or a location between the two. In accordance with the invention, two vertexes can be considered relatively close if a distance (such the Euclidean distance) between the vertexes is less than a predefined threshold. Thus, after each polygon is rotated, each of its vertexes is processed to determine its proximity to the vertexes of any adjacent previously rotated polygons. In an illustrative embodiment, the vertices whose projections in the texture space are less than 0.25 pixels apart are brought together automatically. In addition, vertices are brought together if it results in all of the polygon's sides being changed in length by less than a factor of 20%. If bringing together of the vertices changes the length of any of the polygon's sides by more than a factor of 20%, the vertices are left apart. In an alternative embodiment, a different metric of polygon distortion can be used to make the choice. Although a slight distortion in the final image may result, the adjacent polygons are less likely to have spaces or cracks between them.

In accordance with the invention, adjacent polygons are identified by searching for polygons that share a common edge with any of the rotated polygons. Thus, for example, in FIG. 1A, polygons B′ and C′ share the edge between vertexes 12 and 14, and therefore polygon C′ is considered adjacent to polygon B′.

If rotating a new polygon into the plane of the polygon chosen to be the starting polygon results in the new polygon overlapping another polygon that has already been rotated, the new polygon is put back into the queue of polygons and is processed later. A polygon is considered to be overlapping another polygon when either of the following is true: at least one vertex of one polygon is located inside the area of another polygon; at least one of the edges of one polygon passes through the area of another polygon.

When a polygon cannot be rotated without overlapping another polygon, the polygon can be discarded or the polygon can be resolved to fit within the space defined by the adjacent polygons. A polygon can be resolved to fit within the space defined by the adjacent polygons by moving its vertexes to lie along the perimeter of the space defined or to the location of the vertexes of the adjacent polygons. In some situations it may be necessary to divide the polygon into two or more polygons in order for it to fit with cracks or spaces.

When there are no more polygons left in the queue to be processed, the set of projected polygons that has been generated is stored in memory where it can subsequently be accessed.

After a first set of projected polygons has been created, the steps described above can be repeated one or more times as necessary to meet the requirements for the resulting representation. In addition, if after the first iteration, there are remaining polygons that could not be rotated, one of the unrotated polygons can be selected for the second or a subsequent iteration in order to ensure that all the polygons are rotated and the ratio of texture area to surface area is nearly constant. Where high resolution or quality representation are indicated, a second or third iteration can be used to produce a ratio of texture area to surface area that is very nearly constant. Where speed is more important than the quality or resolution, the representation can be processed using only a single iteration to rotate the images to provide a substantially constant ratio of texture area to surface area. In the second iteration, a second starting polygon is chosen and a second set of projected polygons is created using the steps described above. This process can be utilized multiple times until each polygon in the mesh of polygons derived from the three dimensional model has been rotated and has become a part of a set of rotated polygons. This typically results in at least as many, and usually more, rotated sets than there were original polygons.

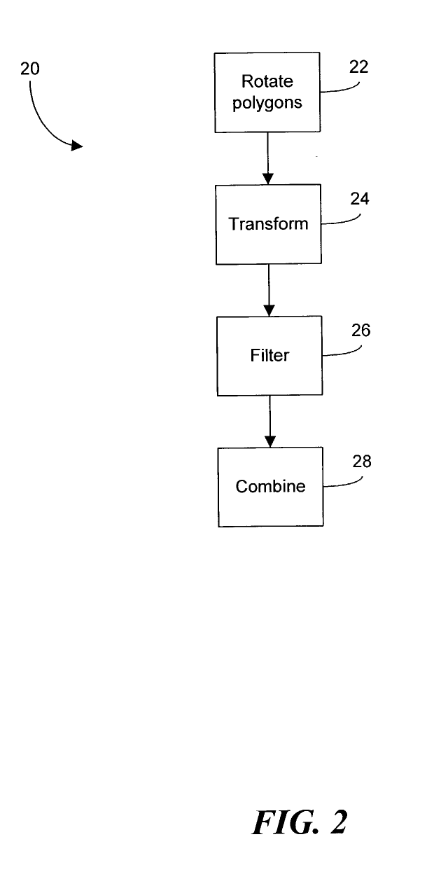

FIG. 2 shows the unwrapping process 20. The unwrapping process 20 includes the steps of rotating the polygons of the representation 22, and using a transform 24 and a filter 26 to render the unwrapped image. After the image is unwrapped, it can be combined with other unwrapped images 28 which often results in visible seams.

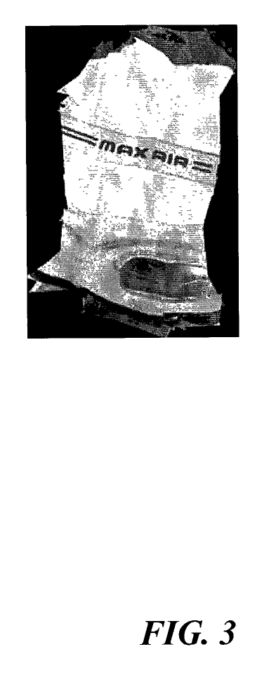

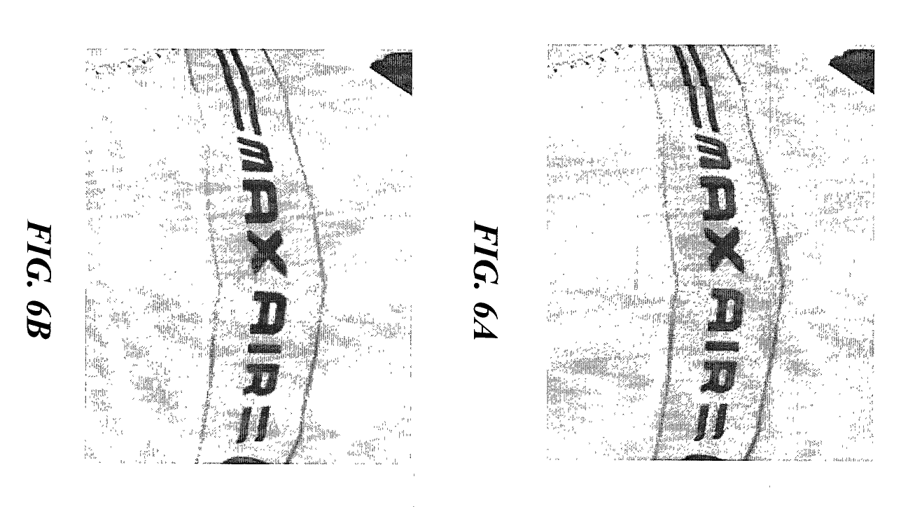

Each rotated set of polygons can then be rendered as an image using an affine transformation 24 of the original photographs, and suitable filtering 26, such as bilinear interpolation and box filtering. The set of images can then be stored separately, or merged into a set of composite images. The position of each polygon vertex in a rotated polygon becomes the new texture coordinate for that vertex, and the polygon becomes the new texture for the polygon using that vertex. FIG. 3 depicts an unwrapped three dimensional model of a sneaker after the photograph of the sneaker was processed using the steps described above. In order to make the model shown in FIG. 3 more realistic, it is often desirable to feather the edges of the image. FIG. 6A shows the back of the same sneaker with clearly visible edges on the right and left of the figure.

The feathering technique is used to conceal or soften the transition or seams between texture maps of adjacent photographs. Undesirable seams are often visible in 3D models when more than one photograph is used to derive texture data for the 3D model. In one embodiment, the feathering process includes looking or searching a 3D model for any visible seams or sharp transitions. The feathering process of the present invention can be used to reduce the visibility of seams by utilizing the feathering process that is applied to areas adjacent to the edges where the visible seam appears. In general the feathering technique of this embodiment involves ensuring a smooth transition of the colors near the edge to those at the edge.

In accordance with the invention, the visible edge can be a boundary or a line having a pair of texture coordinates corresponding to each end and can be the starting point for the feathering process. In one embodiment, the user can define a starting point at or close to the edge where he or she wishes the blending technique to be implemented. Alternatively, a default distance of a few pixels from the edge can be the starting point for the blending technique to begin.

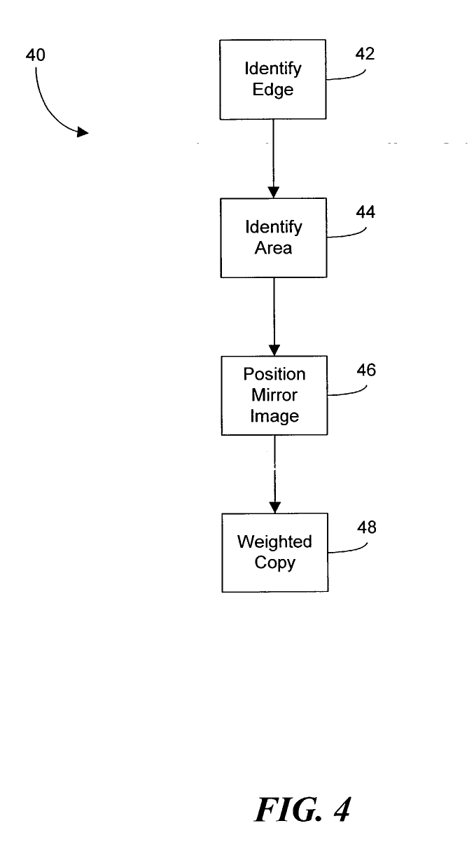

The feathering process is shown in FIGS. 4 through 6. As shown in FIG. 4, the feathering process includes the steps of a) identifying an edge or boundary line along which the texture is to be transitioned 42, b) identify an area to be feathered 44, c) overlaying a mirror image of the adjacent photograph onto the area to be feathered 46 and d) using a weighted copy operation copy the mirror image onto the area to be feathered 48. The weighted copy operation is used to vary the attributes (pixel color, saturation and brightness for example) of the copied mirror image as a function of the distance from the edge or boundary line. In one embodiment at least one of the attributes is reduced or minimized linearly as the distance from the edge increases.

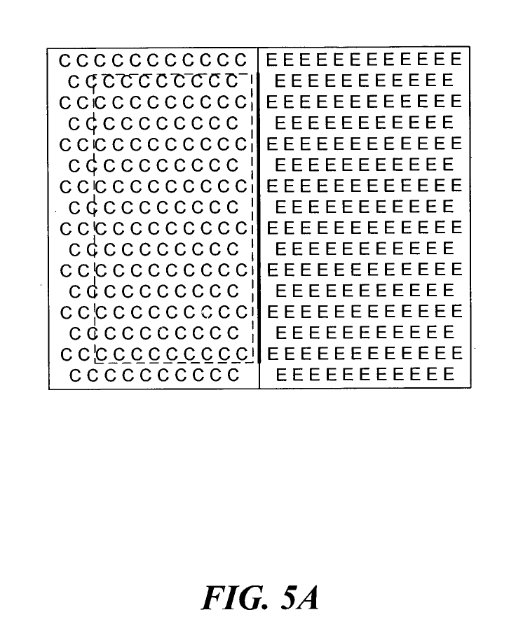

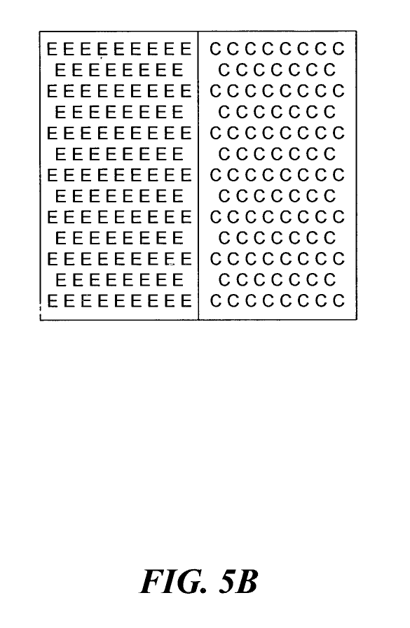

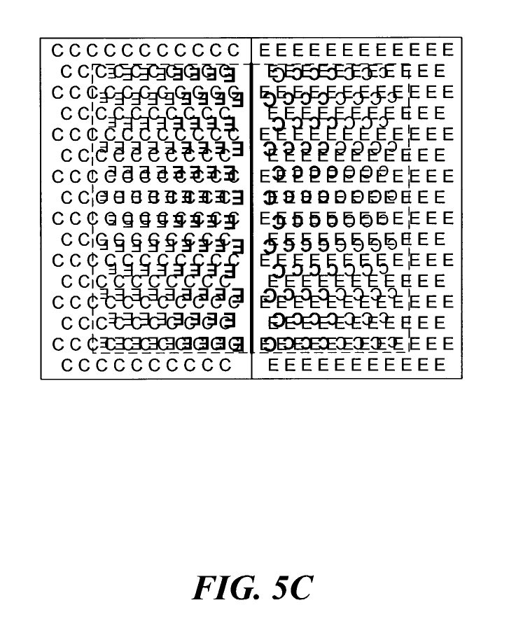

One embodiment of the feathering process of the invention is shown in FIGS. 5A-5C. The feathering process includes identifying an area 52 adjacent to the boundary of photographs C and E as shown in FIG. 5A. Next an edge buffer 56 is created from the texture areas adjacent the edge as shown in FIG. 5B. In the final steps, a mirror image of the edge buffer is overlaid upon the area to be feathered and a weighted copy operation is used to copy the mirror image onto the area to be feathered as shown in FIG. 5C. The weighted copy operation adjusts certain attributes of an element of the texture to be feathered in order to reduce its affect on the text as a function of the distance from the edge or boundary. For purposes of illustration, the weighted copy operation is shown using the E character with varying size and intensity in FIG. 5C.

The weighted copy operation can be a function of a pixel color, P and its distance from the edge to be feathered. P can be defined as follows: P=[Redₚ Greenₚ Blueₚ] where Colorₚ is the intensity of a given pixel color. A second pixel color, M could be chosen, wherein M is exactly opposite of P using the edge to be feathered as a center line between P and M. M could be comprised of the following colors M=[Redₘ Greenₘ Blueₘ] where Colorₘ is the intensity of a given pixel color. A blending value a could be defined wherein a is a linear function of the distance between the pixel and the edge being feathered. Alpha, for example, can be equal 0.5 at the edge to be feathered and 0.0 at a predefined distance from the edge. A second value β, which could be the complement of α, could be defined such that β=1−α. The weighted copy can be applied on a pixel by pixel basis to the area to be feathered and be a function of P, M, α, β and the distance of the pixel from the edge to be feathered.

Alternatively, the Red, Green, and Blue measurements for P and M, the two pixel colors could be transformed into a Hue, Saturation, and Brightness coordinate system. Once this transformation is made, the Saturation and Brightness components for each color pixel could be blended as a function, such as using the linear weights, of α and β. In addition, the Hue component for each color pixel could remain unchanged. In an alternate embodiment, if the two Hue components are close to each other, they could also be blended using the aforementioned weights. FIG. 6B shows the sneaker image of FIG. 3 after the feathering technique described herein has been applied.

In accordance with one embodiment of the invention,—a computer is provided with a set of digital images of an object and a three dimensional geometric model of the object, represented as a mesh of polygons. Each polygon includes a set of texture coordinates at each vertex that indicate the spatial correlation between said digital images and the model. The unwrapping process includes re-orienting

In one embodiment, the present invention can be embodied in a computer system, such as Sparc computer system from SUN Microsystems, Inc. of Palo Alto, Calif. A computer program using the JAVA programming language can be used to implement the unwrapping and feathering processes. The JAVA language is operable in many operating environments including the Solaris Operating System from SUN Microsystems, the Windows family of Operating Systems from Microsoft Corp. of Redmond, Wash., the Macintosh Operation System from Apple Computer, Inc., of Cupertino, Calif., the Linux operating system available from Red Hat, Inc. of Raleigh, N.C., and other computer systems, including IBM Compatible personal computer systems can also be used.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of creating a seamless transition between a plurality of textures in a three dimensional model of an object, said model including a plurality of polygons corresponding to a portion of said object and a plurality of textures associated with a plurality of said polygons, said method comprising the steps of:
A) unwrapping said polygons whereby a ratio of a texture area to a surface area of at least some of said polygons is substantially constant; and
B) feathering a first area having a first texture adjacent to a transition between said first texture and a second texture with a mirror image of the second texture.

2. A method of creating a seamless transition according to claim 1 wherein the unwrapping step further includes the step of re-orienting each polygon such that substantially all the polygons in a given area are oriented to lie in a common plane.

3. A method of creating a seamless transition according to claim 2 wherein the unwrapping step further includes changing the position of at least one vertex of at least one re-oriented polygon in order to position said vertex at the same location as a vertex of an adjacent polygon.

4. A method of creating a seamless transition according to claim 2 wherein the unwrapping step further includes rendering an image of a planar area using an affine transformation.

5. A method of creating a seamless transition according to claim 4 wherein the unwrapping step further includes rendering an image of a planar area using a filtering processes.

6. A method of creating a seamless transition according to claim 5 wherein the filtering process further includes bilinear interpolation.

7. A method of creating a seamless transition according to claim 5 wherein the filtering process further includes box filtering.

8. A method of creating a seamless transition according to claim 1 wherein the feathering step further includes the step of copying the mirror image of the second texture onto the first area having the first texture.

9. A method of creating a seamless transition according to claim 8 wherein the copying step is a weighted copy process that adjusts at least one attribute of an area of the mirror image of the second texture as a function of a distance relative to the transition.

10. A method of creating a seamless transition according to claim 9 wherein said area is a single pixel.

11. A method of creating a seamless transition according to claim 9 wherein said area is a set of pixels.

12. A method of creating a seamless transition according to claim 9 wherein said at least one attribute of an area of the mirror image of the second texture is a value representative of a color intensity of said area.

13. A method of creating a seamless transition according to claim 9 wherein said at least one attribute of an area of the mirror image of the second texture is a value representative of a color saturation of said area.

14. A method of creating a seamless transition according to claim 9 wherein said at least one attribute of an area of the mirror image of the second texture is a value representative of a color brightness of said area.

15. A method of creating a seamless transition according to claim 9 wherein said at least one attribute of an area of the mirror image of the second texture is a value representative of a color hue of said area.

16. A method of creating a seamless transition according to claim 15 wherein said at least one attribute of an area of the mirror image of the second texture does not include a value representative of a color hue of said area if said color hue of said area is substantially different from a color hue of a corresponding area of said first texture.

17. A method of creating a seamless transition according to claim 8 wherein the copying step is a weighted copy process that adjusts at least one attribute of an area of the mirror image of the second texture as a function of a distance relative to the transition and an attribute of the first texture at the distance from the transition.

18. An apparatus for creating a seamless transition between a plurality of textures in a three dimensional model of an object, said model including a plurality of polygons corresponding to a portion of said object and a plurality of textures associated with a plurality of said polygons, said apparatus comprising:
a computer having at least one associated processor and associated storage memory;
an unwrapping module adapted for unwrapping said polygons whereby a ratio of a texture area to a surface area of at least some of said polygons is substantially constant; and
a feathering module for feathering a first area having a first texture adjacent to a transition between said first texture and a second texture with a mirror image of the second texture.

19. An apparatus for creating a seamless transition according to claim 18 wherein the unwrapping module includes a system for re-orienting each polygon such that substantially all the polygons in a given area are oriented to lie in a common plane.

20. An apparatus for creating a seamless transition according to claim 19 wherein the unwrapping module further includes a system for changing the position of at least one vertex of at least one re-oriented polygon in order to position said vertex at the same location as a vertex of an adjacent polygon.

21. An apparatus for creating a seamless transition according to claim 19 wherein the unwrapping module further includes a system for rendering an image of a planar area using an affine transformation.

22. An apparatus for creating a seamless transition according to claim 21 wherein the unwrapping component further includes a filtering system adapted for rendering an image of a planar area using a filtering processes.

23. An apparatus for creating a seamless transition according to claim 22 wherein the filtering system is further adapted to render an image using a bilinear interpolation process.

24. An apparatus for creating a seamless transition according to claim 22 wherein the filtering system is further adapted to render an image using a box filtering process.

25. An apparatus for creating a seamless transition according to claim 18 wherein the feathering module includes a copying system for copying the mirror image of the second texture onto the first area having the first texture.

26. An apparatus for creating a seamless transition according to claim 25 wherein the copying system is adapted to perform a weighted copy process that adjusts at least one attribute of an area of the mirror image of the second texture as a function of a distance relative to the transition.

27. An apparatus for creating a seamless transition according to claim 26 wherein said area is a single pixel.

28. An apparatus for creating a seamless transition according to claim 26 wherein said area is a set of pixels.

29. An apparatus for creating a seamless transition according to claim 26 wherein said at least one attribute of an area of the mirror image of the second texture is a value representative of a color intensity of said area.

30. An apparatus for creating a seamless transition according to claim 26 wherein said at least one attribute of an area of the mirror image of the second texture is a value representative of a color saturation of said area.

31. An apparatus for creating a seamless transition according to claim 26 wherein said at least one attribute of an area of the mirror image of the second texture is a value representative of a color brightness of said area.

32. An apparatus for creating a seamless transition according to claim 26 wherein said at least one attribute of an area of the mirror image of the second texture is a value representative of a color hue of said area.

33. An apparatus for creating a seamless transition according to claim 32 wherein said at least one attribute of an area of the mirror image of the second texture does not include a value representative of a color hue of said area if said color hue of said area is substantially different from a color hue of a corresponding area of said first texture.

34. An apparatus for creating a seamless transition according to claim 25 wherein the copying system is adapted for performing a weighted copy process that adjusts at least one attribute of an area of the mirror image of the second texture as a function of a distance relative to the transition and an attribute of the first texture at the distance from the transition.
